(19) United States
(12) Patent Application Publication
(10) Pub. No.: US 2017/0172108 A1
(43) Pub. Date: Jun. 22, 2017

(54) Cat Scratching System

(71) Applicants: Earnest Franklin Long, JR., Charlotte, NC (US); Eric Wayne Myhre, Falls Church, VA (US)

(72) Inventors: Earnest Franklin Long, JR., Charlotte, NC (US); Eric Wayne Myhre, Falls Church, VA (US)

(21) Appl. No.: 15/375,173

(22) Filed: Dec. 12, 2016

Related U.S. Application Data
(60) Provisional application No. 62/268,364, filed on Dec. 16, 2015.

(51) Int. Cl. A01K 15/02

(52) U.S. Cl. CPC A01K 15/024

(57) ABSTRACT

A cat scratching system consisting of at least one scratching surface, a physical base, and a snap button system, wherein the snap button system allows for the attachment and detachment of the scratching surface to and from the physical base.

This application claims the benefit of Applicants' prior provisional application, No. 62/268,364, filed on Dec. 16, 2015.

### BACKGROUND OF THE INVENTION

The present invention is in the technical field of cat scratchers. More particularly, the present invention is in the technical field of removable cat scratchers.

Scratching is a natural, instinctive behavior for felines. They do it for a variety of reasons, including marking their territory and relieving stress. As part of their behavioral instinct to scratch, cats will frequently satisfy their need by scratching furniture, sofas and other household objects with favorable textures.

Pet product vendors have offered the cat scratcher, found in many different forms, including the scratching post and other shapes and designs, as a way to redirect cat scratching from furniture and household objects to the cat scratching device instead.

Typically, cat scratchers involve two major components: (1) a scratching surface, consisting of scratching material, and (2) a physical structure or base. The scratching material usually consists of sisal, sea grass, carpet, or cardboard, but a variety of materials can be used. In the majority of cat scratchers, the scratching material is permanently affixed to the base.

Naturally, scratching has a destructive effect on the cat scratching material, however the base typically remains intact. The lifespan of a typical cat scratching surface depends on the quality of its construction and scratching material, as well as the amount of use—it can be as little as a couple of months, up to several years. Its destruction, however, is inevitable.

For cat scratchers in which the scratching surface is permanently attached to the base, the user typically must discard the entire cat scratcher when the scratching surface has become destroyed.

To solve this problem, several vendors have created removable cat scratching systems, allowing the scratching material to be removed from the physical base of the cat scratching system for replacement.

Various designs and mechanical mechanisms have been used to accomplish this attachment and detachment of the scratching surface from the physical base of the cat scratcher.

The invention described herein depicts a novel cat scratching system, involving a more efficient system to accomplish the goal of providing a cat scratching system with the ability to remove and detach the scratching surface from the physical base, allowing for greater ease of use and enhanced structural integrity of the system.

### SUMMARY OF THE INVENTION

The present invention is a cat scratching system, consisting of at least one scratching surface, a physical base, and a snap button fastening system (consisting of a snap button stud affixed to the physical base, a snap button cap affixed to the top side of the scratching surface, and a snap button socket affixed to the bottom side of the scratching surface), wherein the snap button system allows for the attachment and detachment of the scratching surface to and from the physical base.

Furthermore, scratching surfaces with the aforementioned snap button fastening system can be interchanged, allowing for different scratching surfaces to be attached to the physical base at different times.

### BRIEF DESCRIPTIONS OF THE DRAWINGS

FIG. 1, FIG. 6, FIG. 7, and FIG. 8 depict several example designs of the invention (the cat scratching system) with varying shapes and sizes of the scratching surface and physical base. Each consists of a snap button fastening system, where a snap button stud is affixed to the physical base, a snap button cap is affixed to the top side of the scratching surface, and a snap button socket is affixed to the bottom side of the scratching surface.

FIG. 1 is a three-quarter view of an example of the cat scratching system, in an arched design, with scratching surface, physical base and snap button fastening system.

FIG. 2 is a perspective view (side) of the cat scratching system aforementioned in FIG. 1.

FIG. 3 is a labelled close-up of the components within the snap button fastening system (magnified view of the right portion of FIG. 2).

FIG. 4 is an exploded view of the snap button system without the scratching surface or physical base.

FIG. 5 is an exploded view of FIG. 1, depicting the scratching surface detached from the physical base.

FIG. 6 is an example of the cat scratching system in an ornamental flat design, with scratching surface, physical base and snap button fastening system.

FIG. 7 is an example of a cat scratcher in traditional post design, with scratching surface, physical base and snap button fastening system.

FIG. 8 is an example of a cat scratcher in a cat hideaway/perch design, with scratching surface, physical base and snap button fastening system.

### DETAILED DESCRIPTION OF THE INVENTION

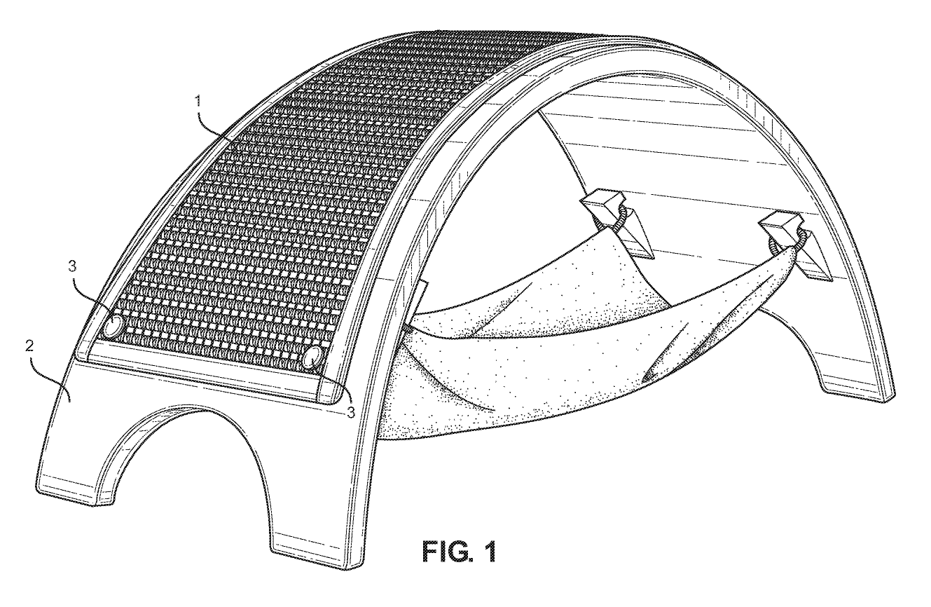

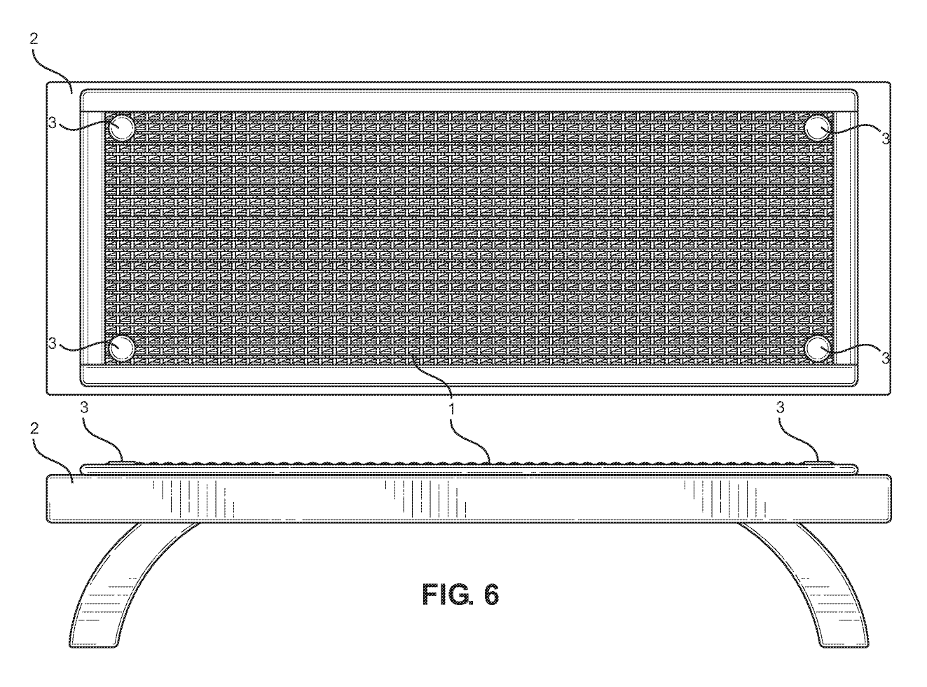

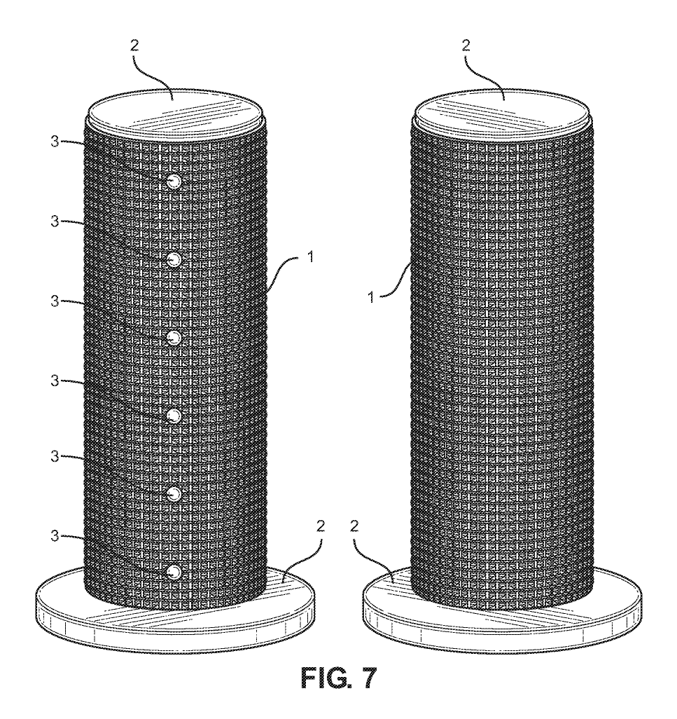

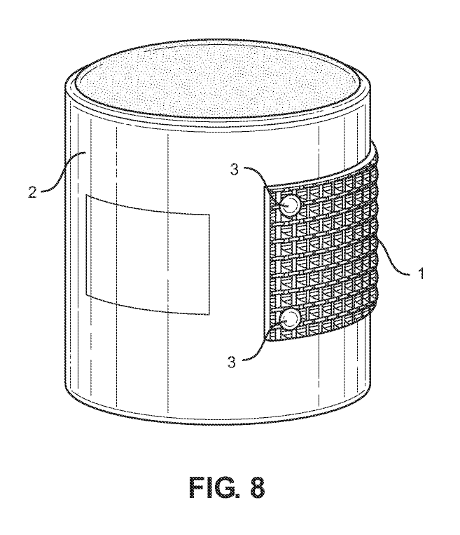

Referring to FIG. 1, FIG. 6, FIG. 7, and FIG. 8, the invention is a cat scratching system which consists of at least one scratching surface, 1, a physical base, 2, and a snap button fastening system, 3, (consisting of a snap button stud, 6, affixed to the physical base, a snap button cap, 4, affixed to the top side of the scratching surface, and a snap button socket, 5, affixed to the bottom side of the scratching surface), wherein the snap button fastening system allows for the attachment and detachment of the scratching surface to and from the physical base.

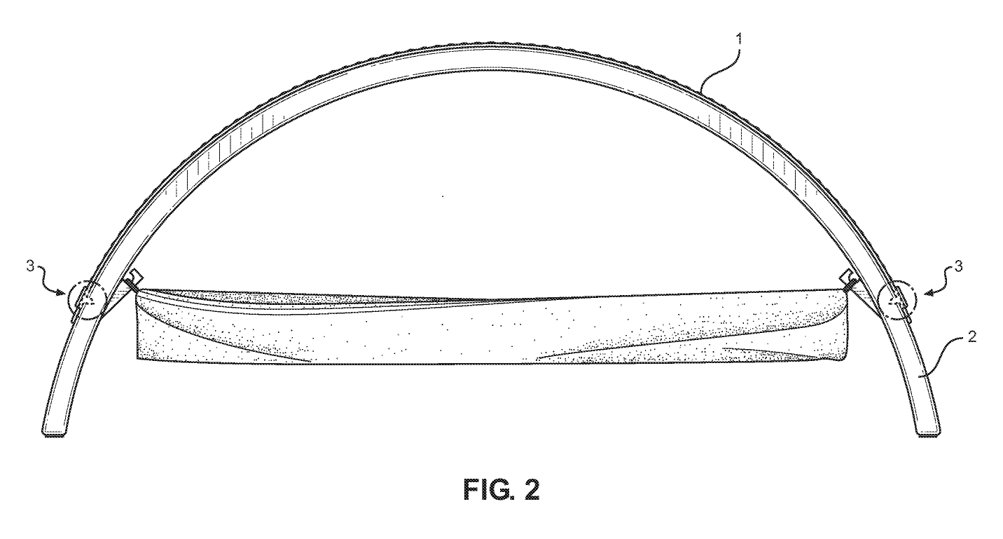

Referring now to FIG. 2, a perspective view (side) of the invention is shown. Of note is the attachment of the snap button fastening system, 3, on both ends of the device, which mates the scratching surface, 1, and the physical base, 2.

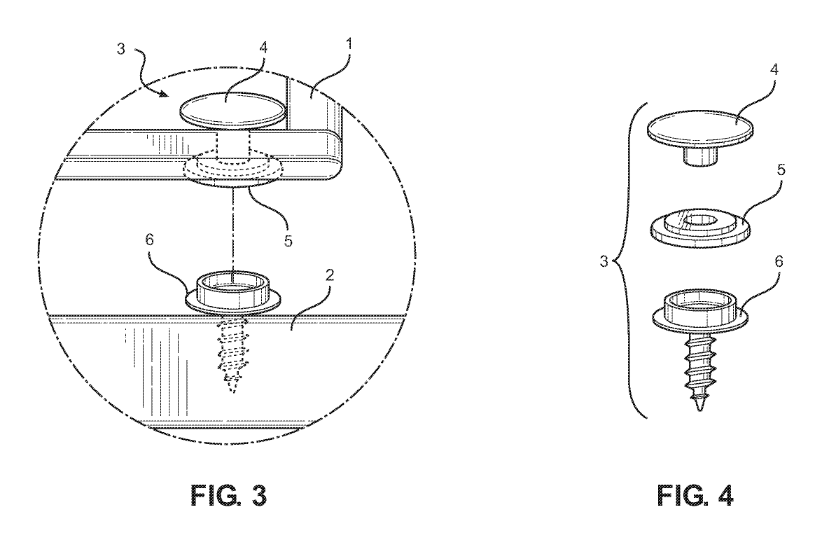

Referring now to FIG. 3, a snap button stud, 6, is affixed to the physical base, 2, a snap button cap, 4, is affixed to the top side of the scratching surface, 1, and a snap button socket, 5, is affixed to the bottom side of the scratching surface.

Referring now to FIG. 4, the snap button fastening system is shown separate from the physical base and scratching surface, in an exploded view. The fastening system is made up of the snap button cap, 4, the snap button socket, 5, and the snap button stud, 6.

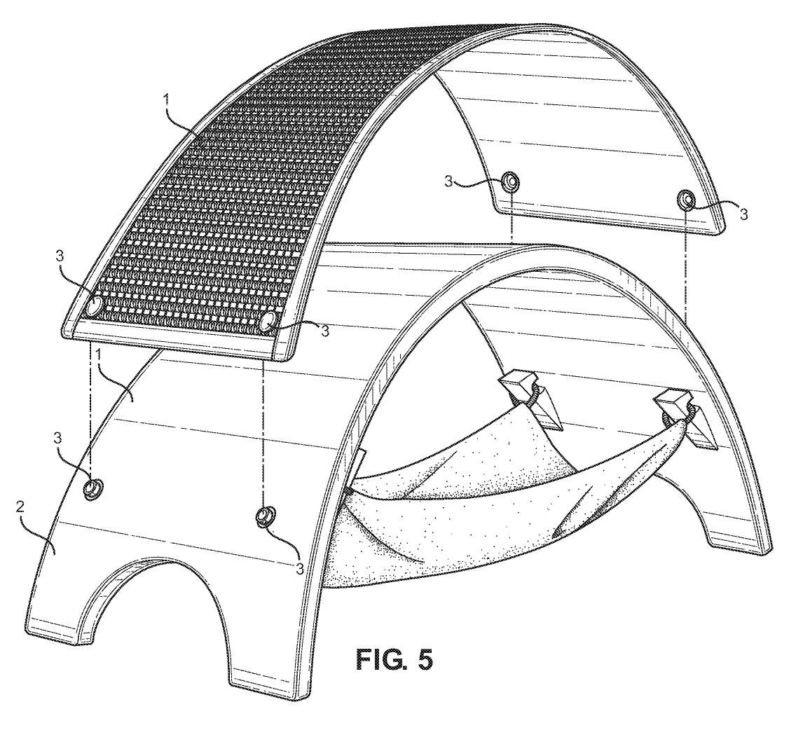

Referring now to FIG. 5, the scratching surface, 1, is shown detached from the physical base, 2, with the snap button fastening system, 3, ready to attach the scratching surface and physical base.

What is claimed is:

1. A cat scratching system, consisting of at least one scratching surface, a physical base, and a snap button fastening system (consisting of a snap button stud affixed to the physical base, a snap button cap affixed to the top side of the scratching surface, and a snap button socket affixed to the bottom side of the scratching surface), wherein the snap button fastening system allows for the attachment and detachment of the scratching surface to and from the physical base.

2. A cat scratching system, consisting of at least one scratching surface, a physical base, and a snap button fastening system (consisting of a snap button stud affixed to the physical base, a snap button cap affixed to the top side of the scratching surface, and a snap button socket affixed to the bottom side of the scratching surface), wherein the snap button fastening system allows for the attachment and detachment of scratching surfaces of variable materials and types to and from the physical base.
